(19) United States
(12) Patent Application Publication
(10) Pub. No.: US 2015/0104556 A1
(43) Pub. Date: Apr. 16, 2015

(54) FUNCTIONAL CREAM BASE POWDER COMPOSITION AND PRODUCTS MADE THEREOF

(71) Applicant: INTERNATIONAL FOODSTUFFS COMPANY LLC, Sharjah (AE)

(72) Inventors: Virinder KUMAR, Sharjah (AE); Fathima Waheeda Mohideen, Sharjah (AE); Joe Anibal Trujillo Quijano, Dubai (AE)

(73) Assignee: INTERNATIONAL FOODSTUFFS COMPANY LLC, Sharjah (AE)

(21) Appl. No.: 14/055,516

(22) Filed: Oct. 16, 2013

(51) Int. Cl. A23C 13/12

(52) U.S. Cl. CPC A23C 13/125
USPC 426/565; 426/586; 426/570; 426/579; 426/589

(57) ABSTRACT

The present invention relates to a spray dried cream base powder which can be used as an alternative to dairy creams and other liquid cooking creams. The powdered cooking cream composition comprise of 20-60% by weight fat, 1-5% by weight one or more proteins, 0.5-5% by weight one or more emulsifier system, 1-6% by weight native/modified starch, 1-5% by weight water and the balance is made up of non-starchy carbohydrates, buffering agents and stabilizers. Optionally flavor, colour and anticaking agents can be incorporated in the composition. The above composition can be used directly or after reconstituted with water, to prepare foods such as curries, gravies, soup and sauces. The cream base powder can be conveniently used to develop processed food products such as soft serve ice cream, whipped toppings, mousse, Instant dry mix soup products and milk based puddings.

### BACKGROUND

The invention pertains to cooking creams. Predominantly, the invention relates to a spray dried non-dairy fat emulsion which on reconstitution with water enables the food manufacturer/preparer to rapidly and conveniently create a wide variety of textured foods such as curries, gravies, soups, sauces, instant mousse desserts, whipped toppings, milk puddings, and soft serve ice creams. The powder is readily soluble in cold and hot water, and reconstituted liquid is stable at cooking temperatures.

US patent 2010/0136199 A1 and EP 1555892B1, UHT liquid cooking cream product with a whipping capability is known, which is prepared from hydrogenated vegetable fat, butter milk powder, starch, emulsifier, stabilizer and buffering agents. The product preferably has 45% solids and able to withstand cooking temperatures.

In EP 0 459 562 B1 disclose a process related to liquid cooking cream. This patent describes a cooking cream following a health trend by means of having a low saturated fatty acids/polyunsaturated fatty acid ratio for their fat component. The saturated to polyunsaturated ratio can go low as 0.9. However nothing is disclosed about the product shelf life and heat stability.

US patent 2004/0076731 A1 discloses a powdered fat composition contain 10-80% by weight of hydrogenated crystallizing fat, 0.5-15% one or more proteins, 0.3-20% emulsifier and 1-4% wt of water. The balance is made up of carbohydrates and, optionally with 0-10 wt% of stabilizer, gelling agent, thickener and processing aids. This powdered composition can be conveniently converted into a low fat spread by hydrating the powder to have a water content of 60-85%. The reconstituted product is cooled in a refrigerator to obtain a plastic solid. This patent further advocate of using above powdered composition to prepare dips, mousse, ice cream, spread and food based cosmetics. However this powdered composition do not concern about cooking applications.

Cooking creams are becoming a popular alternative to dairy creams which offer certain benefits such as thermal stability, acid stability, consistent quality and price. The powdered form of cooking cream has greater shelf life, less transportation and packaging cost over liquid counterpart. Present-day Instant reconstitutable powdered products are abundantly used in households and food service. This is mainly due to increasing demand for more and more time saving and convenient food preparation methods.

### SUMMARY OF THE SUBJECT MATTER

The invention is cream base powder which can be used for cooking with the purpose of thicken curries, gravies, soups, sauces; to develop instant milk base desserts, whipped toppings, dry soup mixes and soft serve ice creams. The powder comprises about 1 to 5% by weight water, about 20 to 60% by weight fat, about 10 to 50% by weight non-starchy carbohydrate, about 1 to 5% by weight one or more proteins, about 1 to 6% by weight native/modified starch, about 0.5 to 5% by weight one or more of emulsifier. Preferably cream base powder may also contain effective amount of stabilizers and buffers; appropriate natural or artificial dairy or cream flavors and flavor enhancers. The invention is a functional cream base powder product which has good solubility and able to increase in viscosity at high temperatures used in cooking applications.

### BRIEF DESCRIPTION OF THE TABLES

Table 1 shows contemplated composition of a cream base powder in the form of an emulsion prior to spray drying, and in the final powder.

Table 2 shows contemplated composition of a whipped topping prepared using cream base powder

Table 3 shows contemplated composition of a soft serve ice cream prepared using cream base powder

Table 4 shows contemplated composition of a vanilla pudding prepared using cream base powder

Table 5 shows contemplated composition of a chocolate pudding prepared using cream base powder

Table 6 shows contemplated composition of a chocolate mousse prepared using cream base powder

Table 7 shows contemplated composition of an instant dry mix of tomato soup product prepared using cream base powder

### DETAILED DESCRIPTION

The spray dried cream base powder contain about 1-5% water. Preferably powder contains 2-3% water.

The cream base powder composition of the present invention contains about 20 to 60% by weight of an edible fat containing one or more fats, wherein the fat component is preferably solid or semi-solid at room temperature. The fat component can selected from numerous sources. Preferably the fat component is of animal, vegetable or dairy origin. The refined and deodorized fat component can be selected from plant oils, such as soybean oil, sunflower oil, canola oil, palm oil, palm kernel oil, coconut oil, safflower oil, corn oil, olive oil, peanut oil and cotton seed oil which can be used alone or as a mixture of two or more thereof. Hydrogenated, Fractionated, interesterified chemically or enzymatically, single or combination of two or more fat used can be selected according to the final use of the powder. The fat should be additivated with antioxidants such as Natural (tocopherol/ascorbyl palmitate) or synthetic ones. Preferably ascorbyl palmitate or oleate can be used at levels of 100-400 ppm.

The fat component having more crystallized fat in low temperature is suitable for product applications such as whipped toppings and mousse. Preferably a fat component roughly having 70-93% crystallized fat at 20° C. and 15-38% crystallized fat at 30° C. measured by pulsed NMR according to the AOCS method cd 16693 or IUPAC parallel method 2.150a is important for overrun and whipping structure in these products.

Preferably the protein component can be selected from dairy or plant sources. Suitable proteins are derived from caseinates, whey protein concentrate or isolates, Skimmed milk powder (low or high heat), butter milk powder, soy protein concentrate or isolates, wheat proteins and pea protein isolates. Combination of one or more protein is also possible to use in the present invention. Emulsifying plant extracts such as gum Arabic, and modified starches like octenyl succinic acid (OSA) with emulsifying properties can be used along with protein sources to form stable oil in water emulsions.

Range of conventional emulsifiers can be used to build the emulsifier system in the products along with the protein component. Examples of conventional emulsifiers are mono and diglycerides of fatty acids, organic acid ester derivatives of mono and diglycerides (Acetic acid esters of mono and diglycerides of fatty acids, Lactic acid esters of mono and diglycerides of fatty acids, Citric acid esters of mono and diglycerides of fatty acids, mono and diacetyl tartacric esters of mono and diglycerides of fatty acids). Other emulsifiers which can be aid in the formation of emulsion are soy lecithin, polysorbate 60, polysorbate 65, polysorbate 80. The usage of combinations of emulsifier is preferable to have better final product properties.

The non-starchy carbohydrate is included in the present invention as required for quality, flavor characteristic and ease of production. Carbohydrates are bulking agents which encapsulate the emulsified fat during spray drying. Better Encapsulated fat produce cream base powders with good thermal stability with better keeping qualities. Carbohydrate usable in the composition preferably comprises corn syrup solids, malto-dextrin 10 to 19 DE (dextrose equivalent) range, Sucrose, fructose, dextrose and maltose.

The starch component is used in cooking cream powders to provide thickening ability when heated to higher temperatures. Preferably native corn starch or cross linked modified starches are used which has an ability to increase viscosity at temperatures above 75° C. Sources of modified starch include corn, potato, tapioca, maize, wheat, rice and sorghum. Alone or a Combination of starches can be used for the present invention.

Emulsion stabilizers are used in present invention to aid in solubility, emulsion stability and maintenance of pH. Preferably chemical stabilizers are used in the invention. The chemical stabilizers may comprise disodium phosphate, dipotassium phosphate and sodium citrate. The dipotassium phosphate and potassium phosphate are most preferred emulsion stabilizers in the present invention.

The cream base powder composition of the present invention may include natural or artificial flavors to provide dairy or cream like flavor. Flavors in liquid form can be added to the prepared emulsions prior to spray drying, or dried form can be dry blended into powders. Preferably salt is used to enhance the flavor of cream base powders.

The powder composition of the present invention may also include optional additives typically used in spray dried food powder compositions such as anticaking agents and whitening agents. The preferred anticaking agents are tri calcium phosphate and silicon dioxide. Titanium dioxide may be used as whitening agent in the present invention. The additives are added in varying amounts, typically about 0.01-5% of the powder.

Preferably, a cream base powder composition (Table 1) according to the present invention comprises the following components in the emulsion prior to spray drying and in the final powder:

| | % emulsion | % powder |
|---|---|---|
| | Before spray | After spray |
| Ingredient | drying | drying |
| Vegetable fat or dairy fat or animal fat | 10-30 | 20-60 |
| With antioxidants | | |
| Maltodextrin/Corn syrup solids/sucrose | 10-30% | 10-50% |
| Milk Protein/Soy Protein/Pea Protein | 1-3% | 1-5% |
| Soy lecithin/mono and | 0.1-1% | 0.5-5% |
| diglycerides/polysorbate | | |
| Starch | 0.5-3% | 1-6% |
| Stabilizer/Acidity Regulators | 0.5-2% | 1-3% |
| Salt | 0.1-1% | 0.1-1% |
| *Flavor, colour, anticaking agents, | 0.1-1% | 0.1-0.5% |
| whitening agents | | |
| Water | Balance to 100 | 2-5% |

*flavor, color can be added prior to spray drying, and anticaking agents, whitening agents can be dry blended after spray drying

Another aspect of the invention is a process for the preparation of a powdered cream base powder following above mentioned emulsion formulation. The process comprising the steps of: Preparation of water phase using water soluble ingredients; Preparation of fat phase with melted fat & fat soluble/dispersible ingredients; Addition of fat phase to the water phase and forming an oil in water emulsion (approximately solid content about 40 to 50% by weight) by two-stage homogenization (first stage: about 500 psi; second stage: about 2000 psi); Pasteurization of the emulsion and optional addition of liquid flavor compounds; Spray drying the emulsion in a multi-stage spray dryer at an inlet temperature of 200° C. and outlet temperature of 75° C. After the first stage of drying under the chamber powders are further dried and cooled on a moving belt until they reach temperature roughly below 25° C. The powders are conditioned at 8° C. for 24 hours and subsequently stored at 20° C.

The prepared cream base powder emulsion has 40-50% solid content and the emulsion is spray dried in a multi-stage spray dryer under pressure nozzle atomization. The viscosity of the emulsion should appropriate for spray drying under nozzle atomization. Too thick emulsions result poor atomization and powders with inappropriate particle sizes.

A 100 Kg quantity of cream base powder base was produced by spray drying. The resulting product is a white color free flowing powder with a 30% fat content and 3% moisture content. The cream base powder is a functional product which has good solubility and greater thermal stability.

The one part of above product was rehydrated with equal amount of water, and tested for the performance. The rehydrated product rapidly dissolves in both cold and hot water forming a milky solution. The product was stable in cooking applications at 90° C. for 10 minutes. Compared to liquid cooking creams cram base powder has outstanding temperature stability where liquid creams could show oiling off when boiled longer time. The boiled reconstituted cream base powder does not release oil even it reaches complete dehydration. The appropriately packaged and stored product has a shelf life of 2 years at room temperature storage.

The desired quantity of cream base powder may add into soup (tomato base soup, cream mushroom soup, broccoli cream soup), cream pasta recipes, curries and gravies in order to get rich creamy taste and thickness. The powder can add directly or after reconstitute with water to get a desirable thickness. It is often preferable to use reconstitute powder for above mentioned food preparations.

The following examples are used to illustrate the present invention used to develop processed products, but should not be limited thereto.

### EXAMPLES

### Example 1

A whipped topping was prepared on the basis of the following recipe (Table 2):

| | Wt % |
|---|---|
| Cream base powder (30% fat) | 40% |
| Sucrose | 12% |
| stabilizer | 0.1-3% |
| Starch | 0.1-4% |
| Flavor, colour | 0.1-1% |
| Water balance | 45-50% |

A dry mix for making a whipped topping is prepared following above formulation. All the dry components are mixed together by hand in a container for few seconds. After adding cold milk or cold water, the mixture is beaten using a kitchen aid mixture. At first whip in a slow speed for 1 min to allow all the contents to mix properly with water. After that whip the mixture in a high speed about 5 to 6 minutes until topping thickens and forms light fluffy peaks.

The product obtained has a desirable mouth feel and texture, and capable of an overrun about 190-220%. The product shows no syeneresis and has good rosette stability.

In order to prepare regular whipped topping product sugar, cream base powder and dry stabilizer can be blended to form the final product. In the case of sugar free whipped toppings, instead of sugar appropriate combinations of natural or artificial sweeteners can be used.

### Example 2

A Soft serve Ice cream product was prepared according to the following recipe (Table 3):

| | Wt % |
|---|---|
| Cream base powder (30% fat) | 20% |
| Sucrose | 12% |
| Skimmed Milk Powder | 5% |
| Starch | 2% |
| Flavor, colour | 0.1-1% |
| Water balance | 63-68% |

All the dry ingredients are added under stirring to the chilled water and blended using a hand blender to dissolve completely. Since the cream base powder has a good solubility in cold water, there is no need to use hot water to dissolve it. Preferably this solution can be pasteurized at 82° C. for 20 seconds and cooled to 20° C. A further cooling of the mixture can be carried out in refrigerator until temperature reaches below 4° C. The cold mixture is aerated using a soft serve ice cream machine to the desired overrun and temperature.

The product obtained is capable of an overrun about 25 to 45% depend on the aeration capability of soft serve ice cream machine Soft serve ice cream product having different flavors such as vanilla, mango, strawberry, and chocolate can be produce by adding appropriate flavor and color ingredients.

Homogenization or aging of the mixture is not required. The obtained soft serve product has pleasant eating qualities and meltdown properties.

### Example 3

A milk based vanilla pudding was prepared on the basis of the following recipe (Table 4):

| | Wt % |
|---|---|
| Cream base powder (30% fat) | 25% |
| Sucrose | 15% |
| Skimmed Milk Powder | 3% |
| Starch | 8% |
| Flavor, colour | 0.1-1% |
| Water balance | 50-55% |

The above components were added under stirring to the water at room temperature until all the ingredients are dissolved completely. The mixture is heated for few minutes until thickens and coat back of a metal spoon. The thickened mixture is poured into containers and cooled in refrigerator for one hour.

The obtained product has a pleasant smooth, spoonable and creamy texture. The product does not show syeneresis when stored at refrigerated temperature for 2 days.

### Example 4

Powder formula for chocolate milk pudding (Table 5):

| | Wt % |
|---|---|
| Cream Base powder (30% fat) | 20% |
| Sucrose | 18% |
| Skimmed Milk Powder | 9% |
| Cocoa Powder | 5% |
| Flavor, colour | 0.1-1% |
| Water balance | 50-55% |

The chocolate milk pudding was prepared by adding all above components into water at room temperature under stirring. The processing of the mixture was carried out by heating until mixture thickens enough to coat back of a metal spoon. Pour the mixture in to serving dishes and let cool in a refrigerator for one hour.

The resulting mixture has a smooth, spoonable and creamy texture, and the product was stable at refrigerated temperature for 2 days.

### Example 5

A chocolate mousse product was prepared using cream base powder according to the following recipe (Table 6):

| | Wt % |
|---|---|
| Cream Base Powder (30% fat) | 13% |
| Sucrose | 18% |
| Skimmed Milk Powder | 5% |
| Cocoa Powder | 5% |
| Salt, Chocolate flavor, colour | 0.1-1% |
| Water/Milk | Balance |

The above components were added under stirring to the water at room temperature until all the ingredients are dissolved completely. Above mixture is further cooled and whipped using a kitchen aid mixer to approximately 100% overrun, followed by refrigeration at 5° C. for few hours.

The resulting product has a smooth spoonable texture similar to conventional mousse dessert prepared by gelatin or egg. Preferably the mousse product can be served with whipped topping prepared with cream base powder, and garnished with chopped chocolate.

### Example 6

An instant dry mix tomato soup product was prepared using cream base powder according to the following recipe (Table 7):

| | Wt % |
|---|---|
| Cream base powder (30% fat) | 20% |
| Spray Dried Tomato Powder | 50% |
| Dried Vegetables (carrot, onion, peas . . . etc.) | 5% |
| Spices (garlic, pepper, salt) | 2-5% |
| Dried Croutons, noodles | 5% |
| Colour, flavor, flavor enhancers | 0.1-1% |
| Yeast extract | 0.1-1% |

The Instant dry mix containing above ingredients were prepared. The 32 g of dry mix added under stirring into 100 g of boiling water until all the ingredients are dissolved completely.

The resulting product has a smooth creamy texture and pleasant taste similar to conventional tomato soup prepared with dairy creams. The prepared tomato soup can be garnished with reconstituted cream base powder with water (powder to water 1 to 1.5 ratio).

1. A cream base powder composition comprising
20 to 60% by weight fat,
1 to 5% by weight protein
0.5-5% by weight emulsifier,
1-6% by weight starch
10 to 50% by weight corn syrup solids or non-starchy carbohydrate,
and 1-5% by weight water.

2. The cream base powder of claim 1 further comprising 0.1-5% of effective amount of stabilizer and effective amount of buffering agents. The stabilizer and buffer are selected from disodium phosphate, dipotassium phosphate and sodium citrate.

3. The cream base powder of claim 1 further comprising 0.1-1% of flavoring, coloring and flavor enhancers such as salt.

4. The cream base powder composition of claim 1 comprising 0.1-2% of anticaking agents and whitening agents.

5. Cream base powder composition of claim 1 wherein the fat is selected from animal, marine, vegetable and dairy origin. The plant oils are selected from soybean oil, sunflower oil, canola oil, palm oil, palm kernel oil, coconut oil, safflower oil, corn oil, olive oil, peanut oil and cotton seed oil which can used single or in a combination of several oils.

6. Cream Base Powder composition of claim 5 plant oils can be modified following complete or partial hydrogenation, fractionation and interesterification.

7. The cream base powder claim 1 wherein the one or more protein is selected from caseinates, whey protein concentrate or isolates, non-fat dry milk (low or high heat), butter milk powder, soy protein concentrate or isolates, wheat proteins and pea protein isolate, gum Arabic and modified starch with emulsifying properties.

8. The cream base powder claim 1 wherein the one or more emulsifier is selected from mono and diglycerides of fatty acids, organic acid ester derivatives of mono and diglycerides (acetoglycerides, lactoglycerides, citroglycerides, diacetyl tartacric esters of monoglycerides), soy lecithin, polysorbate 60, polysorbate 65, polysorbate 80.

9. The cream base powder claim 1 wherein the one or more non-starchy carbohydrate bulking agent is selected from Sucrose, corn syrup solids, malto-dextrin 10 to 19 DE range, fructose, dextrose and maltose.

10. The cream base powder claim 1 wherein starch component is selected from native corn starch or cross linked modified starch having thickening ability. The sources of starch include corn, potato, tapioca, maize, wheat, rice and sorghum.

11. The process of preparing cream base powder claim 1 wherein the composition comprising the steps of dissolving all dry ingredients in the water phase, dissolving all the fat soluble/dispersible components in the fat phase, mixing fat phase with water phase, two stage homogenization to form oil in water emulsion, pasteurization and spray drying in a multi-stage spray dryer through nozzle atomization.

12. The cream base powder of claim 1 wherein the composition rapidly soluble in cold and hot water forming a milky solution.

13. A whipped topping product prepared by mixing the product defined in claim 1.

14. A soft serve ice cream product prepared by mixing the product defined in claim 1 as a cream base with other ingredients.

15. A vanilla or chocolate pudding product prepared by mixing the product defined in claim 1 as a fat base with other ingredients.

16. An instant dry mix of tomato soup product prepared using the product defined in claim 1 as a cream base with other ingredients.
